(19) United States
(12) Patent Application Publication
(10) Pub. No.: US 2013/0176119 A1
(43) Pub. Date: Jul. 11, 2013

(54) VEHICLE ALARM WITH PROTECTION AGAINST POWER SOURCE AND WIRING TAMPERING

(71) Applicant: THOMAS WILLIAM ENGEL, Houston, TX (US)

(72) Inventor: THOMAS WILLIAM ENGEL, Houston, TX (US)

(21) Appl. No.: 13/663,311

(22) Filed: Oct. 29, 2012

Related U.S. Application Data
(60) Provisional application No. 61/552,956, filed on Oct. 28, 2011.
(60) Provisional application No. 61/665,208, filed on Jun. 27, 2012.

(51) Int. Cl. B60Q 5/00

(52) U.S. Cl. CPC B60Q 5/005
USPC 340/428

(57) ABSTRACT

A vehicle alarm system with protection against power source and wiring tampering is provided. For some embodiments, the system may have a dual power source. As such, the alarm system is not easily defeated by simply disconnecting the alarm unit from a siren (or the power source from an alarm unit).

### CROSS-REFERENCE TO RELATED APPLICATIONS

This application claims benefit of U.S. Provisional Patent Application No. 61/552,956, filed Oct. 28, 2011 and entitled “Dual Power Source Car Alarm with Protection against Source and Wiring Tampering,” and U.S. Provisional Patent Application No. 61/665,208, filed Jun. 27, 2012 and entitled “Vehicle Alarm with Protection against Power Source and Wiring Tampering,” both of which are herein incorporated by reference.

### TECHNICAL FIELD

Embodiments of the invention generally relate to security alarm systems and, more particularly, to an anti-intruder alarm for automobiles and other vehicles with protection against power source and/or wiring tampering.

### BACKGROUND

Alarm systems for vehicles (e.g., automobiles, boats, and airplanes) use several different mechanisms to detect intrusion. Perhaps the simplest mechanism involves a single battery power source and a siren. In such a mechanism, the power source is normally disconnected from the siren. However, the system is designed so that a sensor in the vehicle door may activate a switch when the door is impacted or opened abnormally, thereby signifying an intrusion. The switch activation connects the power source with the siren, resulting in sounding of the alarm warning.

More advanced alarm systems are designed to detect and deter would-be thieves who try to enter a vehicle undetected by avoiding opening a door. These systems may include a shock sensor or glass breakage sensor, which senses sound waves caused by the shattering of glass commonly associated with unauthorized entry into a vehicle. A glass breakage sensor may be designed to detect such sound waves and to send an activation signal to an alarm siren when this detection occurs.

These conventional vehicle alarms can be easily defeated by thieves because such alarms are powered exclusively either by the vehicle's standard battery system or a single separate vehicle alarm power battery. A thief can disable the system—or at least render the system ineffective—by severing the battery connection to the alarm unit and/or the wiring between the alarm unit and the siren. Accordingly, what is needed is a vehicle alarm system that is less easily defeated.

### SUMMARY

Embodiments of the invention generally relate to a vehicle alarm system with protection against power source and/or wiring tampering. The system may consist of a logic module, one or more power sources, and one or more sirens or other alarm components acting as the electrical load. Each power source may be capable of powering the entire load at any time, regardless of the condition of the other power source(s). The system includes circuitry for continuously checking the continuity of wires coupling the power source(s) to the load. A lack of continuity with respect to any power source will energize the load through a relay and current reversal network, activating the load and, for some embodiments, outputting a signal to other devices connected with the alarm circuitry.

One embodiment of the invention is an apparatus for protecting a vehicle. The apparatus generally includes first and second sirens, wherein the first siren is associated with a feedback circuit; a main alarm processing unit configured to turn on at least one of the first or second siren if one or more conditions occur; a triggering circuit coupled to the feedback circuit, wherein if a connection between the feedback circuit and the triggering circuit is open circuited, the triggering circuit outputs a signal to the main alarm processing unit to activate the second siren.

### BRIEF DESCRIPTION OF THE DRAWINGS

FIG. 1 is a block diagram of an alarm unit and its various inputs from and outputs to related vehicle circuitry, in accordance with an embodiment of the present disclosure.

FIG. 2 shows one of two power monitoring circuits coupling the alarm unit to one of two sirens via a relay and a current reversal network, in accordance with an embodiment of the present disclosure.

FIG. 3 is a continuation of the diagram of FIG. 2, illustrating a backup battery power source, in accordance with an embodiment of the present disclosure.

FIG. 4 is a block diagram of the power disrupt system module, illustrating the alarm unit, a power monitoring module, two sirens, and various inputs and outputs thereto, in accordance with an embodiment of the present disclosure.

FIG. 5 is a block diagram expanding on the block diagram of FIG. 4, where the alarm unit may be coupled to a security camera, activating the camera when the alarm is tripped and/or receiving images from the camera, in accordance with an embodiment of the present disclosure.

FIG. 6 is a block diagram of the power monitoring module of FIG. 4, illustrating two power monitoring circuits (Circuit A and Circuit B) and a programmable interface for setting various alarm modes, in accordance with an embodiment of the present disclosure.

FIG. 7 illustrates power monitoring Circuit A of FIG. 6, with the feedback from a second siren output to Circuit B, in accordance with an embodiment of the present disclosure.

FIG. 8 is a schematic of the transistorized feedback circuit board, which may be packaged with—or separate and external to—the siren, in accordance with an embodiment of the present disclosure.

FIG. 9 illustrates power monitoring Circuit A of FIG. 6 with a passive feedback card associated with the siren, in accordance with an embodiment of the present disclosure.

FIG. 10 is a schematic of a power monitoring circuit using binary logic with the feedback from the siren, in accordance with an embodiment of the present disclosure.

FIG. 11 is a schematic of a power monitoring circuit using a completely passive feedback system with binary logic, in accordance with an embodiment of the present disclosure.

FIG. 12 is a schematic of a power monitoring circuit with passive feedback from the siren and a transistorized stage with outputs to a delay circuit, in accordance with an embodiment of the present disclosure.

FIG. 13 illustrates a security camera activated by the power monitoring circuit, in accordance with an embodiment of the present disclosure.

FIG. 14 is a block diagram of the power disrupt system module, illustrating the alarm unit, a power monitoring module (a dual siren monitoring module), two sirens, and various inputs and outputs thereto, in accordance with an embodiment of the present disclosure.

FIG. 15 is a block diagram of a dual siren monitoring system with a power protection circuit, in accordance with an embodiment of the present disclosure.

FIG. 16 is a schematic of the dual siren monitoring system of FIG. 15, illustrating the power protection circuit, in accordance with an embodiment of the present disclosure.

FIG. 17 is a schematic of a power protection circuit, such as that of FIG. 15, without a relay on the same circuit board, in accordance with an embodiment of the present disclosure.

FIG. 18 is a schematic of a power protection circuit, such as that of FIG. 15, with a relay on the same circuit board, in accordance with an embodiment of the present disclosure.

FIG. 19 is a schematic of a valet circuit, in accordance with an embodiment of the present disclosure.

FIG. 20 is a schematic of an instant siren wire-cut protection circuit, in accordance with an embodiment of the present disclosure.

FIG. 21 is a schematic of a system check circuit employing an active feedback circuit board, in accordance with an embodiment of the present disclosure.

### DETAILED DESCRIPTION

As described above, certain vehicle alarm systems may be easily defeated by thieves or other intruders. These systems lack the ability to monitor the continuity of system wiring while the system is armed. These systems also lack a second backup battery, meaning that a thief can disable one of these systems by severing the single battery connection to the alarm unit. Embodiments of the present disclosure provide a vehicle alarm system that eliminates these problems by employing power disruption monitoring circuitry and/or a backup battery.

While the alarm systems described herein employ sirens for ease of description, vehicle horns, pre-recorded audio outputs (e.g., verbal warnings) emitted from speakers, still image and/or video cameras, flashing vehicle lights (e.g., parking lights or headlights), or any combination thereof may be substituted for the sirens.

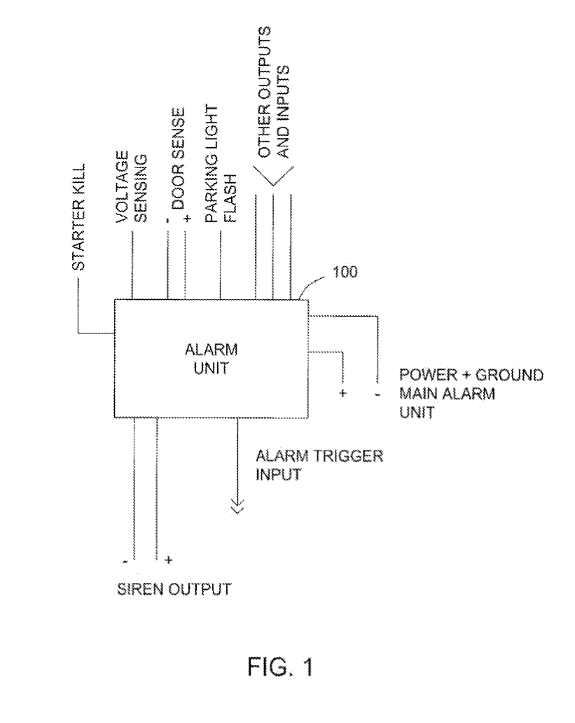

FIG. 1 is a block diagram of an alarm unit 100 and its various inputs from and outputs to related vehicle circuitry within a vehicle alarm system. The alarm unit 100 may receive power from a main battery (e.g., a 12 V wet cell, gel cell, or absorbed glass mat (AGM) battery) or other power source (not shown) via two power connections. For some embodiments, the alarm unit 100 may also be configured to receive power from a backup battery 300, which may be diode- or relay-isolated from the main battery. Inputs to the alarm unit 100 may include an alarm trigger input, a voltage sensing input, and one or more door sensing inputs, for example. Outputs from the alarm unit 100 may include a starter disabler (“starter kill”), a parking light flash, and one or more siren activation signals, for example.

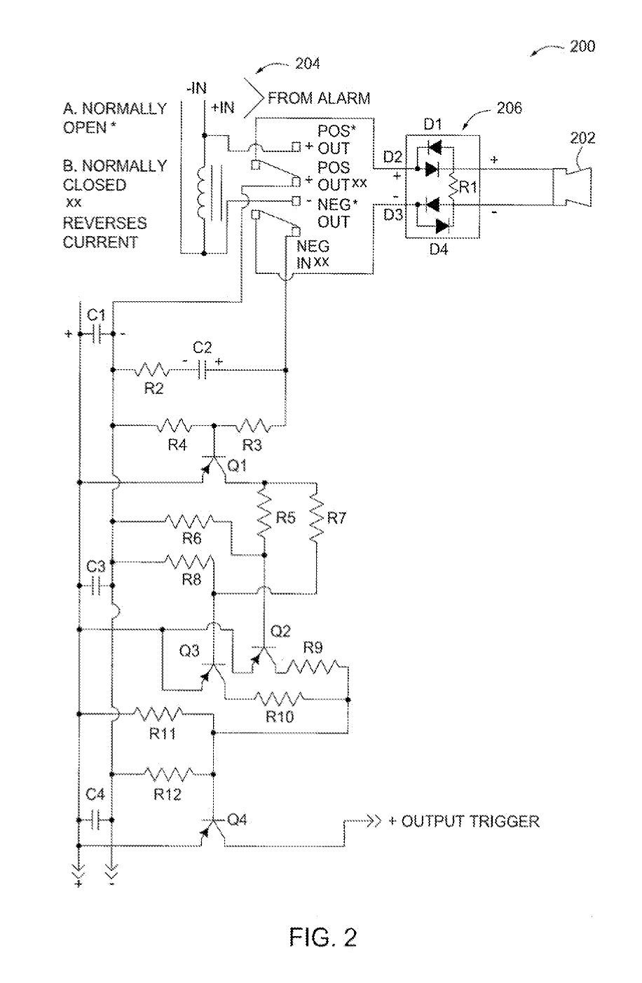

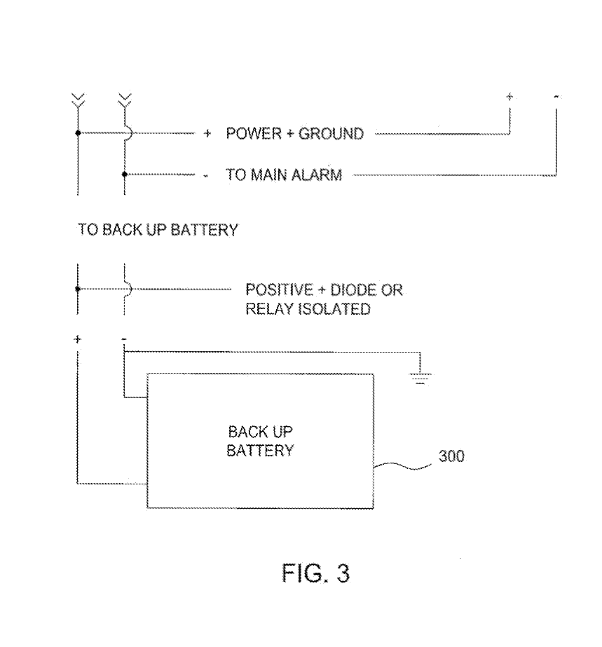

FIGS. 2 and 3 provide a block diagram of a high-end alarm system (aftermarket or provided by an original equipment manufacturer (OEM)). FIG. 2 shows one of two power monitoring circuits 200 coupling the alarm unit 100 to one of two sirens 202 via a relay 204 and a current reversal network 206. The current reversal network 206 allows current to flow in the opposite direction. In FIG. 2, the relay 204 and the current reversal network 206 perform the task of setting the modes of the sirens 202 and feedback to the rest of the circuit. One will note that FIG. 2 only shows one portion of a multiple siren system. FIG. 3 is a continuation of the diagram of FIG. 2, illustrating a backup power source, such as a backup battery 300.

The alarm system may include one or more power source batteries, a logic module (e.g., alarm unit 100), two sirens 202, a feedback unit, and two (2) DPDT (double pole, double throw) relays 204. The feedback unit may be a feedback card (e.g., a printed circuit board (PCB)) with the current reversal network 206. The feedback card may be external to or embedded within the siren 202. The logic module is coupled to each siren 202 by circuitry that is isolated from the connection circuitry of the other siren under normal conditions of electrical continuity and power source availability. This connection circuitry consists of two isolated sides, each side attached to a siren load. For embodiments comprising more than one battery, each siren 202 may be coupled to its own battery power source under normal operation. The circuitry is designed so that under normal operations in which there is wiring continuity throughout the entire system, diode isolation isolates the first and second sides of the circuit.

One of two sensing unit subsystems is incorporated into each side of the circuit. The sensing unit subsystems detect discontinuities in the wires linking the power source to its corresponding normal siren load. The primary component of the sensing unit subsystem is a relay. In the event that a discontinuity in the wiring occurs on either side of the alarm system, the system of relays in the sensing unit of the affected side will enable deactivation of the isolation feature. In that event, the power source—remaining connected to the system through the unaffected side—is able to power both sides of the circuit, and an activation signal is sent to the siren 202 of the unaffected side. For embodiments comprising more than one power source, a severance of any power source from the alarm circuitry will result in the power source connected to the unaffected side picking up the siren load of the affected side through deactivation of the isolation feature.

The siren 202 of the unaffected side may receive an activation signal from the feedback unit associated with the siren 202 of the affected side. The feedback unit connects the input of each siren 202 to the other siren. When a discontinuity occurs, a change in voltage at the power terminals of the affected siren 202 results in the feedback unit sending the activation signal to the unaffected siren 202. In this manner, severing a wire associated with the circuitry of one side of the alarm system will result in activation of the second siren 202, even though there may not be electrical continuity between the logic module and the siren 202 of the affected side.

In the current reversal network 206, diodes D2 and D3 allow current to flow in the typical direction for activating the siren 202. The siren 202 may be activated when the relay 204 is activated by the siren outputs from the alarm unit 100, thereby causing the armature to move from the NC position to the NO position and connecting the siren 202 to the siren outputs from the alarm unit.

In FIG. 2, coupling capacitors C1, C3, and C4 may be disposed between the positive power supply voltage (e.g., +12 V, which although referred to as +12 V, may actually range from 10 to 16 V in a typical vehicle application) and ground (GND) in an effort to short out high frequency transient signals and prevent them from interfering with operation of the rest of the circuit. The emitter of PNP transistor Q1 may be connected with the positive power supply voltage, and resistor R4 may be connected with the base of Q1 and ground. Resistor R3 may be connected with the base of Q1 and the NC terminal of the relay 204. The collector of Q1 may be connected with two resistors R5 and R7, which are connected to the bases of PNP transistors Q2 and Q3, respectively. Resistors R6 and R8 are connected between ground and the bases of Q2 and Q3, respectively. A resistor R9 is connected between the collector of Q2 and the base of PNP transistor Q4, and a resistor R10 is connected between the collector of Q3 and the base of Q4. A resistor R11 is connected between the base of Q4 and the positive power supply voltage, and a resistor R12 is connected between the base of Q4 and ground.

As an example, C1, C2, and C4 may have a value of 10 μF, while C3 may have a value of 0.1 μF. R1 may have a value of 56 Ω; R2 may have a value of 500 kΩ (or may be 0 Ω in some embodiments); R3, R5, R7, and R12 may have a value of 10 kΩ; R4, R6, R8, and R11 may have a value of 100 kΩ; and R9 and R10 may have a value of 0.22 Ω. Q1-Q4 may be 2N2907A transistors, for example.

These elements trigger the relays which can connect the siren load of a first portion of the alarm system to the power source of a second portion of the system in the event of a discontinuity in the first portion. During normal operation, the relays are in the “normally closed” (NC) position, thereby isolating the two portions of the system. In the event of a discontinuity in one portion of the circuit or disconnection of the power source, the relays 204 will move to the open position. The open position results in the remaining connected power source picking up the siren load from the portion of the circuit affected by the discontinuity or power source disconnect.

The alarm system logic module is capable of processing input signals from a variety of commonly used sensors, such as glass-shattering, motion, or proximity sensors. Activation of the door sensor may result in a signal being sent to both sirens 202. Additional output triggering signals (e.g., an output trigger from the collector of Q4) may be sent to trigger one or more other security features, such as a starter disabler (“starter kill”) and/or a parking light flashing mechanism. These signals may be sent simultaneously with any signal sent to the sirens 202.

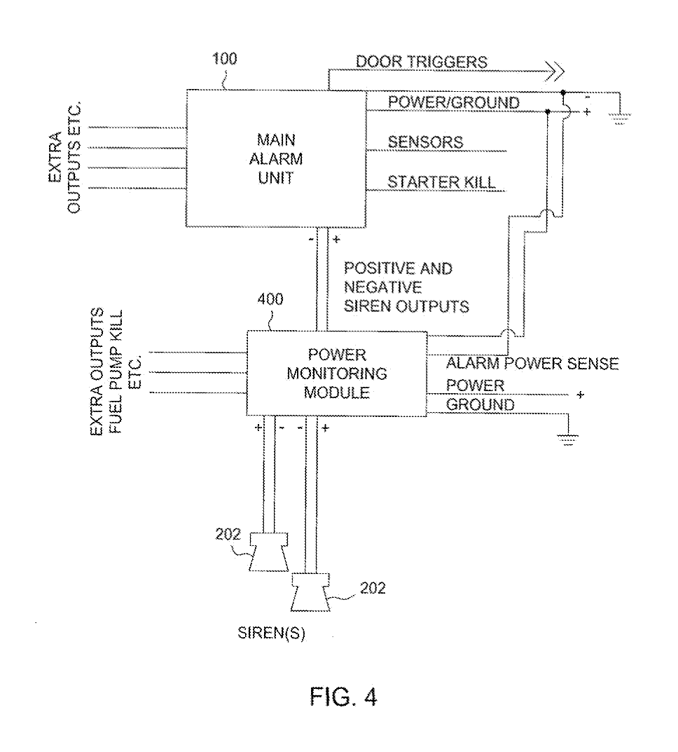

FIG. 4 is a block diagram of the power disrupt system module, illustrating the alarm unit 100, a power monitoring module 400, two sirens 202, and various inputs and outputs thereto. The alarm unit 100 may receive power from a primary battery (i.e., the main battery) and a backup battery, which may be diode- or relay-isolated from the primary battery. Inputs may include at least one of power supply voltage sensing input, one or more door sensing inputs, and a motion sensor input. Outputs may include at least one of a starter disabler (“starter kill”), a parking light flash, one or more siren activation signals, a fuel pump disabler, and any of various other suitable immobilizing outputs or security features.

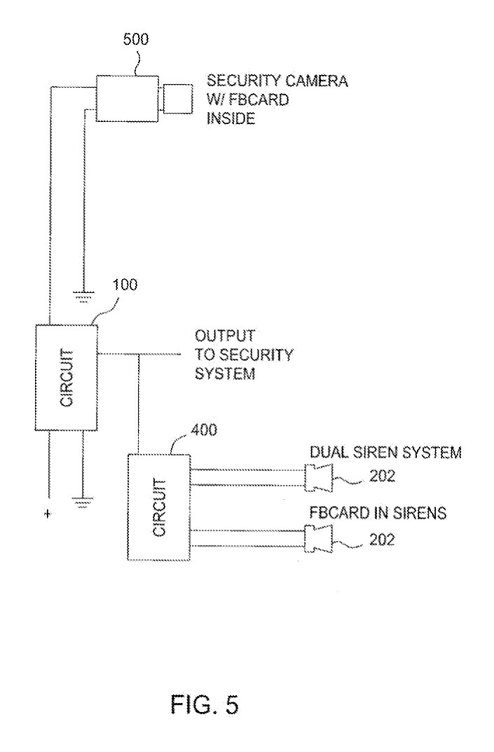

FIG. 5 is a block diagram expanding on the block diagram of FIG. 4. The alarm unit 100 may be coupled to a security camera 500, which may be capable of capturing analog or digital video or photographic images. The alarm unit 100 may activate the camera 500 if the alarm is tripped and/or the alarm unit receives images from the camera. For some embodiments, the camera 500 may work similar to the siren 202 and have a feedback circuit associated therewith. In this case, if the camera 500 is tampered with (e.g., by severing a power connection to the camera) a second camera and/or any other portion of the alarm system may be activated.

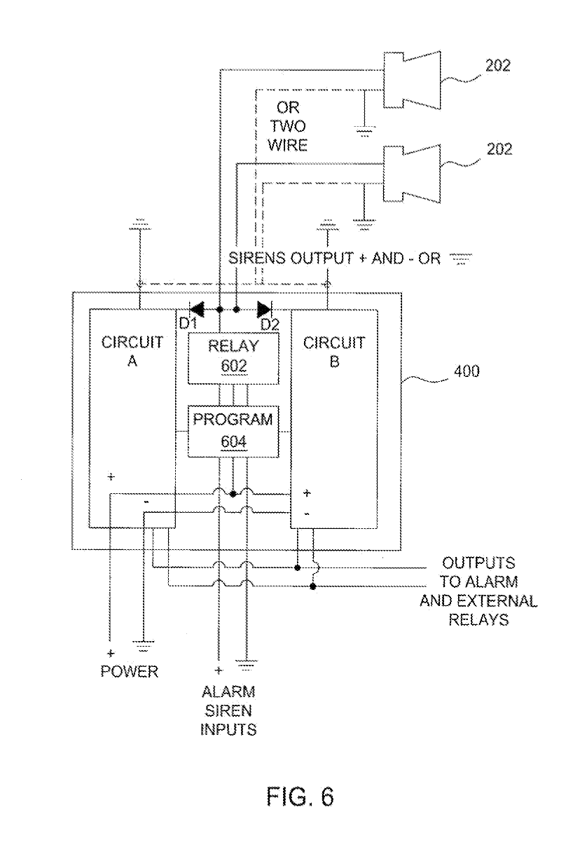

FIG. 6 is a block diagram of the power monitoring module 400 of FIG. 4, illustrating two power monitoring circuits (Circuit A and Circuit B) isolated by diodes D1 and D2, a relay 602, and a programmable interface 604 for setting various alarm modes. The programmable interface 604 may comprise dual in-line package (DIP) switches, for example. In FIG. 6 the feedback cards are installed or built in the sirens 202.

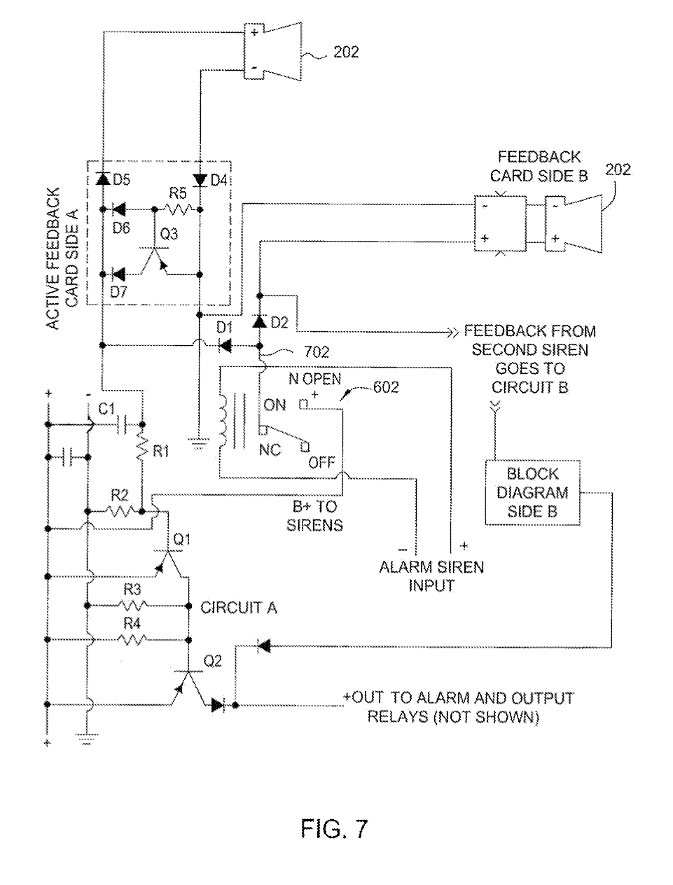

FIG. 7 illustrates power monitoring Circuit A of FIG. 6, with the feedback from a second siren 202 being output to Circuit B. Since Circuit B may match Circuit A, the details of Circuit B are not depicted in FIG. 7. Although the schematic of FIG. 7 illustrates two sirens 202, only one siren may be used for some embodiments.

The alarm siren output of the main alarm unit 100 (i.e., the input of the power monitoring module 400) is connected across the coil of a single pole single throw (SPST) relay 602 where the positive power supply voltage (e.g., +12 V) is connected with the relay's normally open (NO) position. The normally closed (NC) position of the relay 602 is connected with the negative alarm siren input and one end of the relay's coil. When energized, the relay 602 switches from the NC to the NO position and makes a connection between the positive power supply voltage and a common node 702 for activating the sirens 202. In each direction is a diode D1 and D2 separating Circuit A from Circuit B when more than one circuit is used. Current traveling through D1 may normally activate the siren 202 through diodes D5 and D4. In these designs, if there is a good ground connection between the sirens 202 and the module 400 containing the circuits, one may use the chassis as the ground connection, rather than running a second wire to each of the sirens 202, as is done in a two-wire (+ and −) setup.

The + and − wires are connected to the siren 202, which may contain a feedback card. The feedback card may be incorporated into the siren's circuit board for some embodiments. But if the feedback card is separate, the card is connected in series with the circuit board siren connections. The feedback card works by using the ground connection as a feedback by connecting Q3 to the siren activation signal (the node connected with R1, C1, and the cathode of D1) through Q3's emitter and base via R5, which sets the level of feedback Q3 sends back through D7 and down the siren activation signal into the rest of the circuit, similar to circuits described above. In other words, the feedback card uses D6 and R5 to bias Q3 while the siren activation signal is not present. D7 also keeps +12 V out of Q3 and the feedback going in the proper direction. When the siren activation signal is present in the circuit, D4 and D5 allow the current to flow in the normal direction.

When the siren activation signal is not going to the siren (e.g., in the typical situation where the alarm has not been triggered), the feedback will return through the siren activation signal of Circuit A where C1 is used to generate a delay of around 6 to 9 seconds, for example, unless a delay circuit (not shown) is used at the output. This delay prevents the main alarm from being triggered when the alarm is executing its system checks and when the alarm turns off and on. At C1 positive voltage bleeds off creating the delay function. Through the feedback path at R1 and R2 which holds Q1 at its intended voltage and current keeping +12 V going to Q2 keeping that transistor turned off until the feedback stops. R3 and R4 set Q2's operating parameters. When the wire(s) are cut stopping the feedback, Q2 is turned on and sends +12 V to the alarm's sensor input and supplies +12 V to the auxiliary output relays for the fuel cutoff, pagers, etc. This may also be used as a negative trigger if desired.

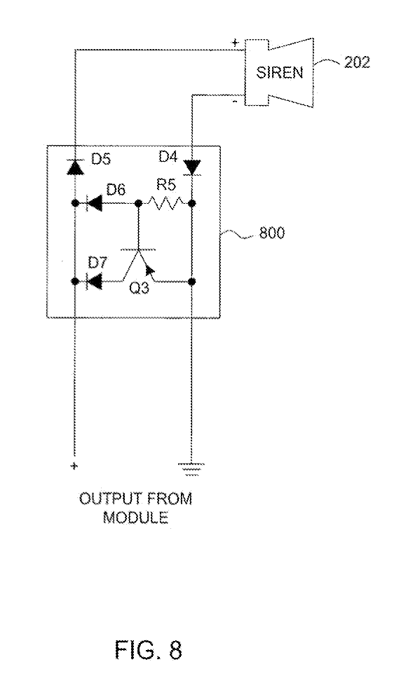

FIG. 8 is a schematic of the transistorized feedback circuit board 800, which is one embodiment of the current reversal network 206. For some embodiments, the feedback circuit may be internal to or packaged with the siren 202. For other embodiments, the feedback circuit may be separate from the siren 202.

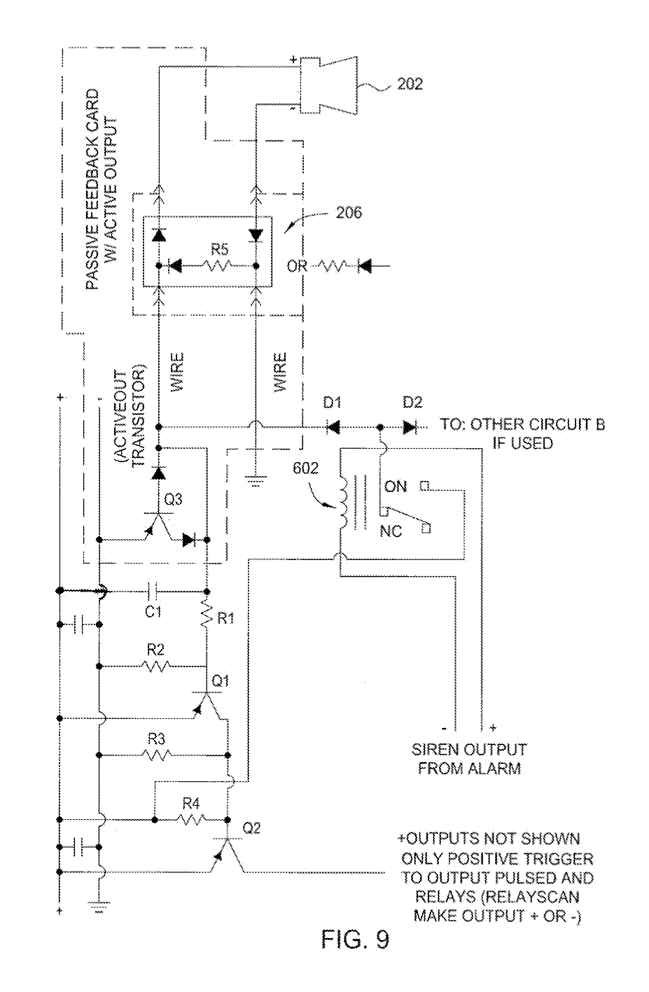

FIG. 9 illustrates power monitoring Circuit A of FIG. 6 with a passive, rather than an active, feedback card associated with the siren. The difference between the active and passive feedback card circuits is that transistor Q3 has been removed from the active card and has been moved to the main circuit board, thereby making the feedback card smaller. Note that R5 may also be moved such that it connects to the base of Q3. There is also a diode in series with the base of Q3 in FIG. 9.

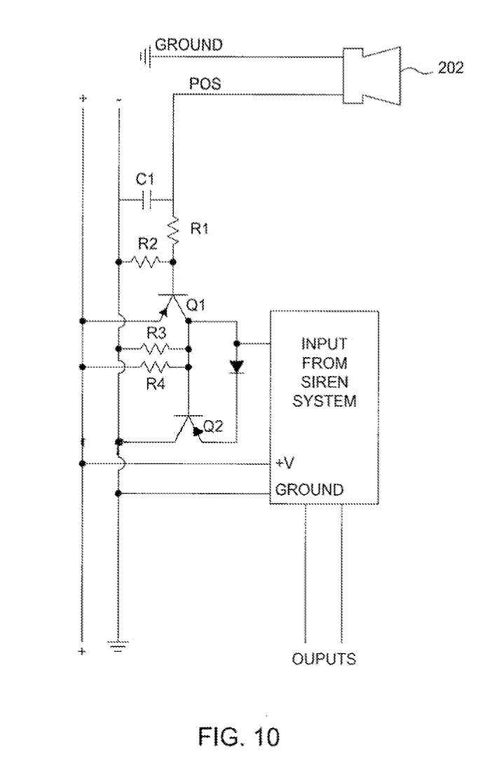

FIG. 10 is a schematic of a power monitoring circuit using binary logic with the feedback from the siren 202. For some embodiments, a time delay circuit may be used. This design is nearly the same in operation as described above with respect to FIGS. 7 and 9, but it differs in that Q1 not only drives Q2, but also outputs +12 V with feedback going high to a programmable integrated circuit (PIC) (binary logic 1). However, when feedback is removed (e.g., the wire is cut), Q2 gets grounded with the loss of +12 V from Q1 shutting down, so Q2 can send ground to the PIC going low (binary logic 0) showing no feedback, and the programmable chip also will receive +12 V from the output relay 602. Being a “smart” system, the alarm system will know whether the alarm is being triggered or if the siren's wire is cut. One will note that neither the relay 602 nor the +12 V connection to the relay 602 is shown in FIG. 10. Furthermore, the second portion of the circuit (Circuit B) is not shown.

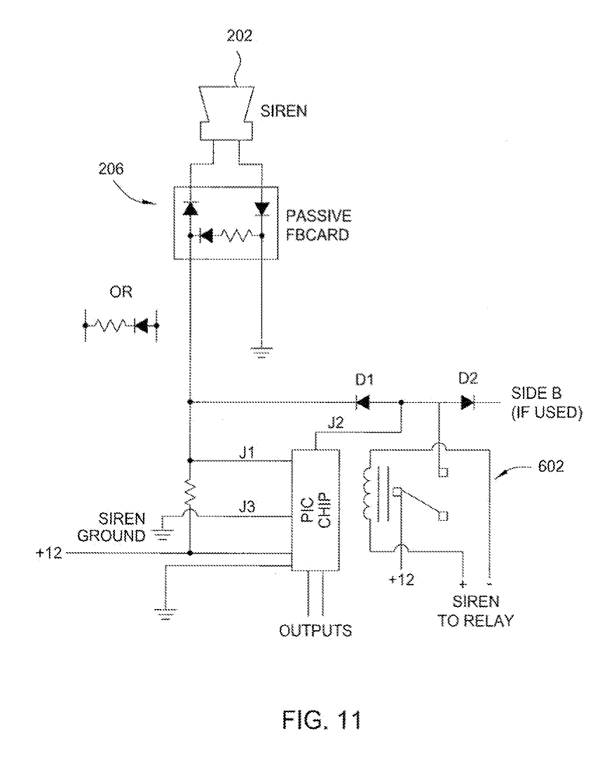

FIG. 11 is a schematic of a power monitoring circuit using a completely passive feedback system with binary logic. For certain embodiments, if a power source wire is cut, the feedback may be interrupted, and the positive supply voltage (typically +12 V) may reach an indicative binary logic level. This design uses the same passive feedback card as described above, except that the R5 resistor value may most likely be lower. For this concept, when there is feedback, the voltage holds down the +12 V which flows through a resistor of sufficient value to keep it at a low state. If any wire is cut (+12 V or ground to the siren), the +12 V will be able to go high at the junction to the PIC or other chip, thus showing the disruption again. A connection from the relay 602 supplying the power +12 V will be connected to the chip at J2, and the chip will determine if the wire is cut by a signal combination of logic 1 at J1 and logic 1 at J2 (i.e., both HIGH) and no current draw at J3. Therefore, logic 1 at J1, logic 1 at J2, and current draw at J3 means the siren is engaged and functioning.

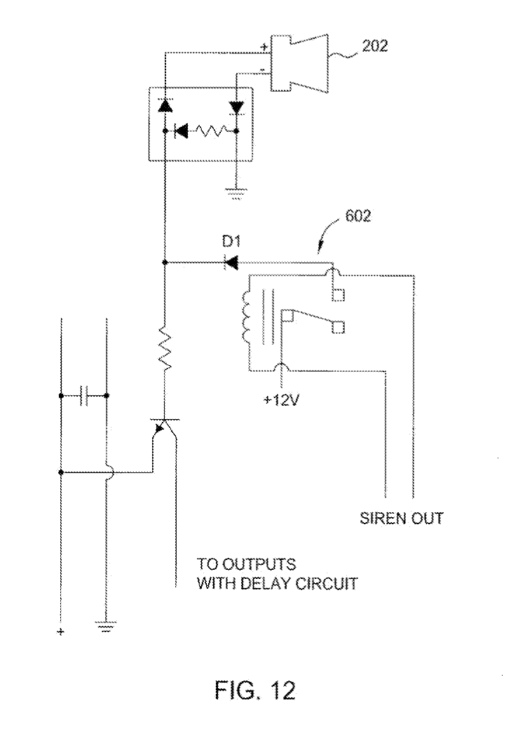

FIG. 12 is a schematic of a power monitoring circuit with passive feedback from the siren 202 and a transistorized stage with outputs to a delay circuit. This passive system may be more useful and easier to use. With the transistor output, the voltage can be changed from + to ground, and the type of transistor can be changed so it can be turned on or off with + or ground.

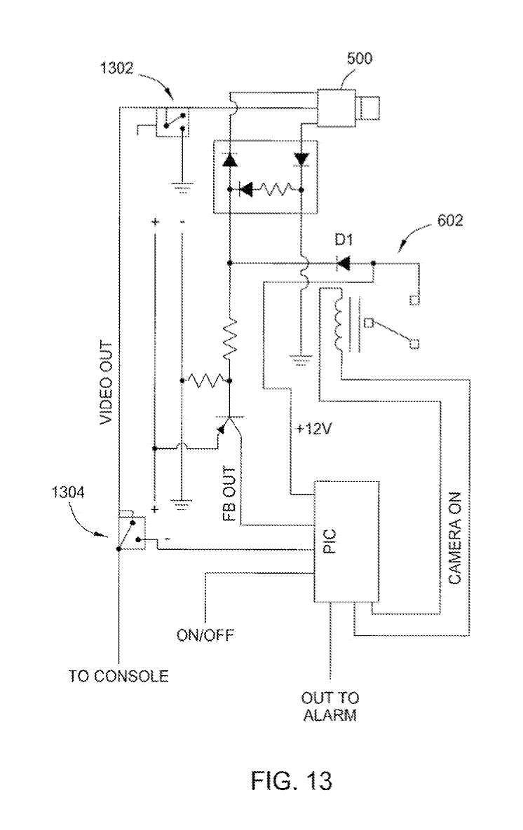

FIG. 13 illustrates a security camera 500 activated by the power monitoring circuit. FIG. 13 is related to the block diagram in FIG. 5. This embodiment may be implemented by slightly modifying the alarm system with a pair of relays 1302, 1304 to change the video feed to a ground signal to check continuity of the video feed after problems with power or ground are detected. An alternate method of checking the video would be either: (1) to check the video signal itself; or (2) to amplify and rectify the video signal and send it to the chip. This system would be useful in monitoring anything from a vessel to a building or home.

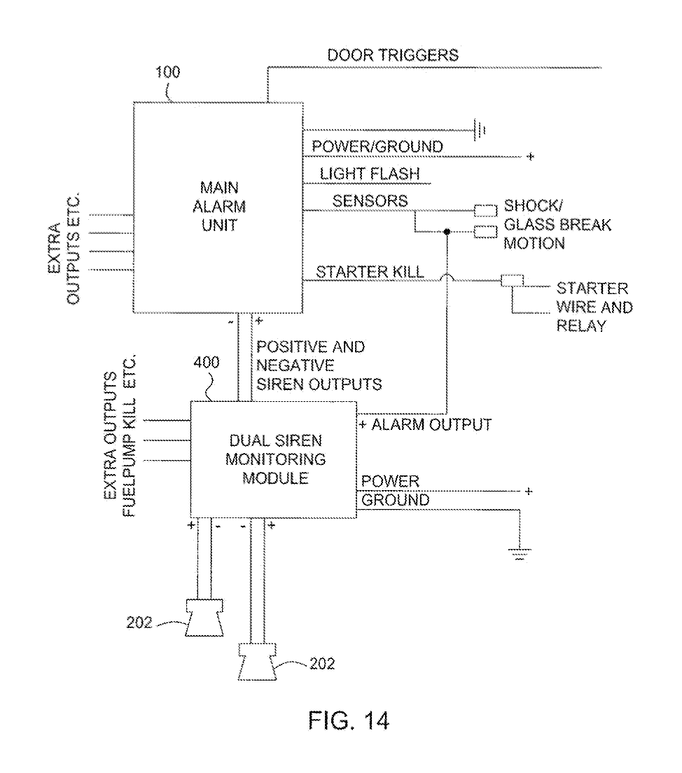

FIG. 14 is a block diagram of the power disrupt system module illustrating the alarm unit 100, a power monitoring module 400 (a dual siren monitoring module), two sirens 202, and various inputs and outputs thereto. This is a simple block diagram illustrating a dual-siren continuity monitoring system.

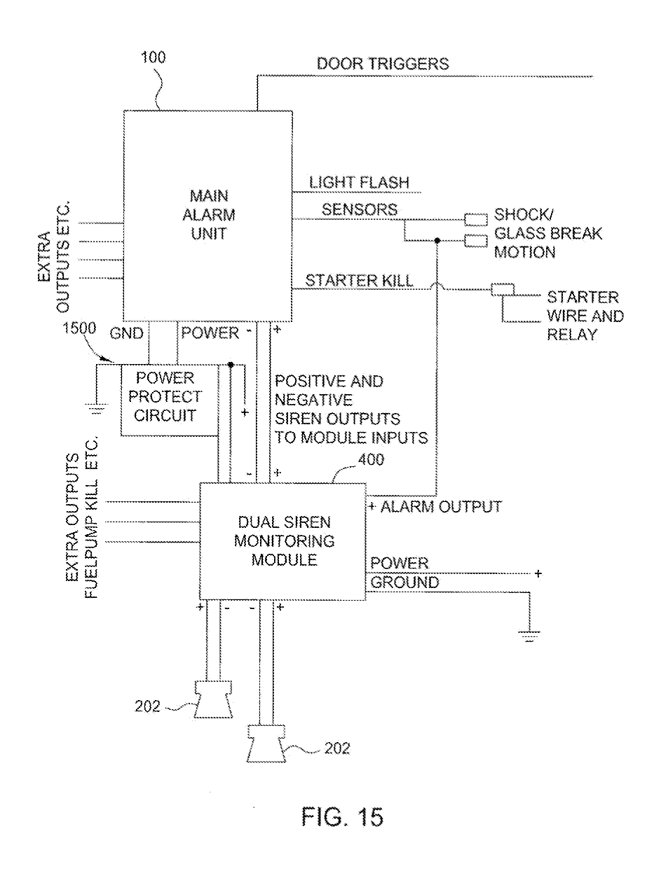

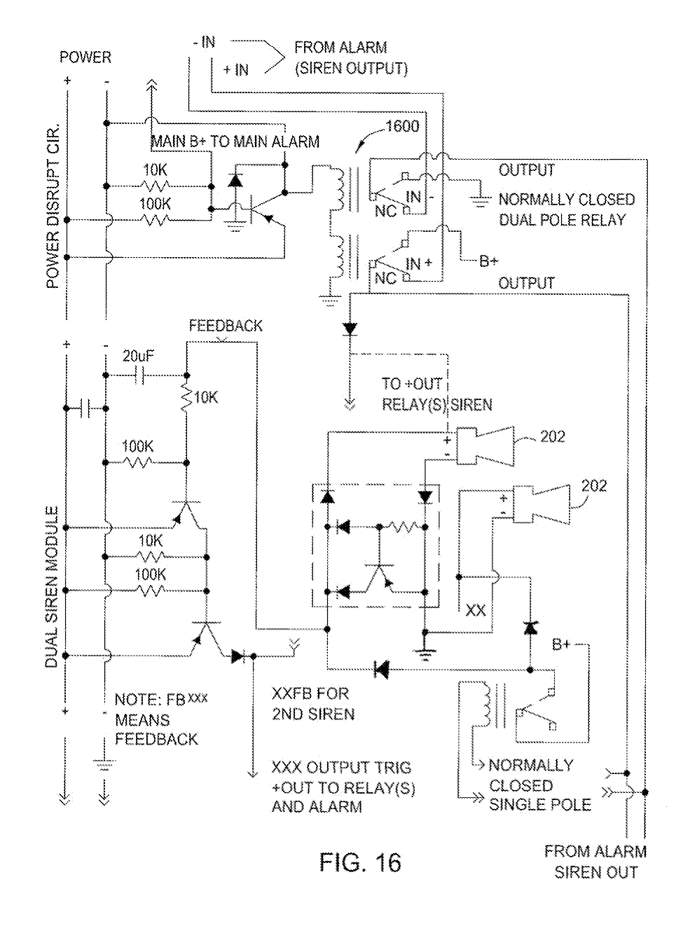

FIG. 15 is a block diagram of a dual-siren monitoring system with a power protection circuit (PPC) 1500. FIG. 16 is a schematic of the dual siren monitoring system of FIG. 15, illustrating the power protection circuit 1500. This schematic of the siren monitoring system has the benefit of the PPC 1500 with a relay 1600 for setting off the sirens if the power wires are tampered with on the main alarm unit 100 or whatever the PPC 1500 is connected to. Although not shown, the +12 V out from the PPC 1500 would normally be connected to the auxiliary (AUX) out relays for fuel cutoff, etc.

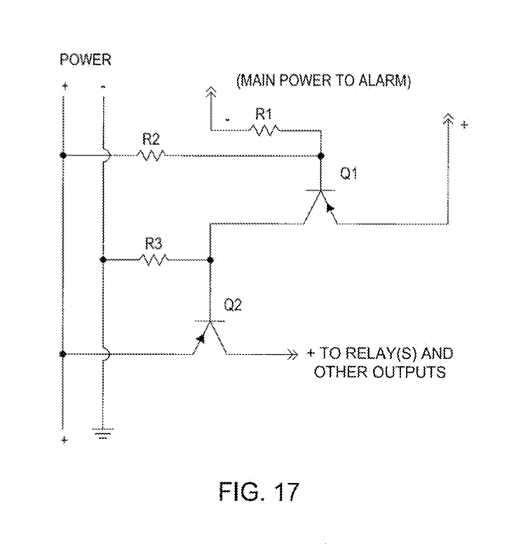

FIG. 17 is a schematic of a power protection circuit, such as that of FIG. 15, without a relay 1600 on the same circuit board.

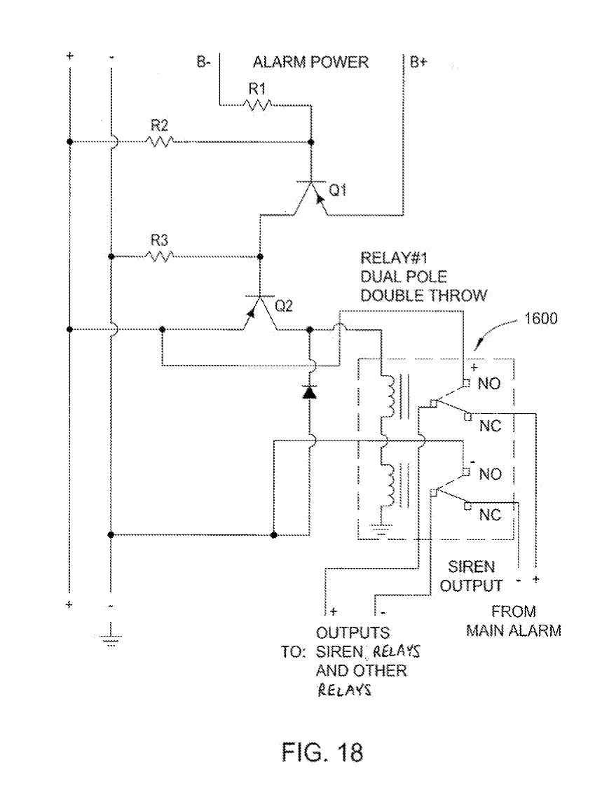

FIG. 18 is a schematic of a power protection circuit, such as that of FIG. 15, with a relay 1600 on the same circuit board. FIG. 4 shows a block diagram of FIG. 18 in a modular format. For all PPC, this may be used in a large alarm system, such as those employed in buildings, homes, etc. Voltage across R1 keeps Q1 turned on. R2 is around ten times higher resistance than R1, and when ground is cut off, +12 V at R2 keeps Q1 off, thus shutting off +12 V or ground may stay connected keeping Q1 on. But if +12 V is disconnected, Q2 will turn on being held on by the ground through R3, Q2 sending the +12 V out when either main +12 V or ground is eliminated. The relay is triggered by Q2 sending +12 V.

For some embodiments, the circuitry of FIG. 7 may be substituted for that of FIG. 2, which shows other revisions in the block diagram of a high quality aftermarket vehicle alarm using the siren system and associated systems, such as FIG. 16, which is FIG. 7 combined with the power protection circuit of FIG. 18.

FIG. 5 is a block diagram of an expansion of the ideas illustrated in FIG. 2, 4, 7, or 18 or may connect to any other alarm system with an installed security camera.

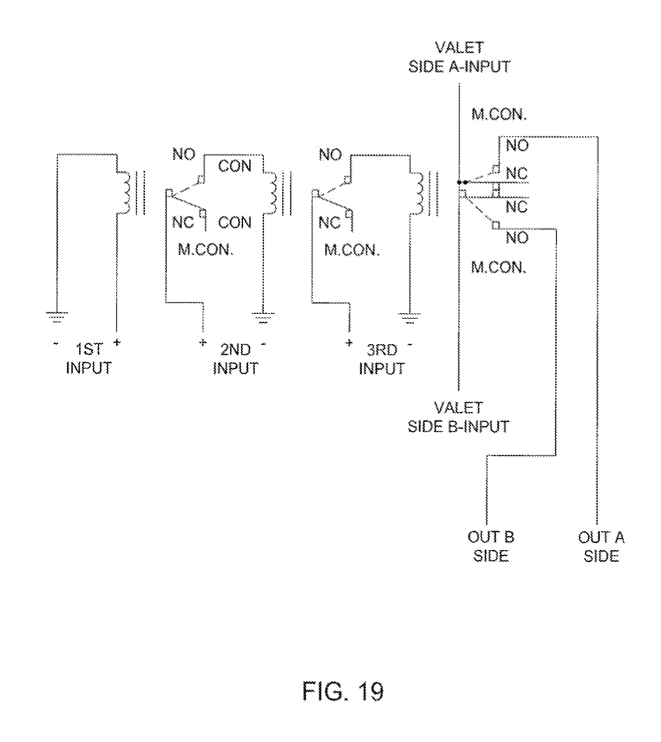

FIG. 19 is a schematic of a 3-to-6-way combination lock valet circuit, which may be combined with certain alarm system circuits described above. As an example, the first input may comprise a dome light signal, the second input may comprise a brake signal, the third input may comprise a rear right window signal.

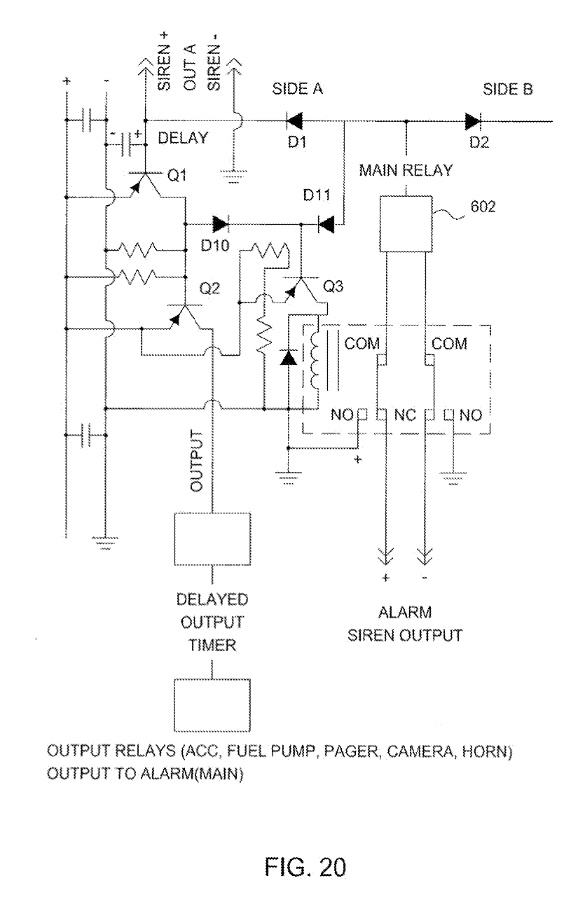

FIG. 20 is a schematic of an instant siren wire-cut protection circuit. When a siren wire is cut or otherwise open circuited, this subsystem may instantly set off an unaffected component, such as another siren, a vehicle horn, and/or vehicle lights. The output may also, or as an alternative, trigger a camera 500 or other optical recording device in an effort to capture a still or video image of such tampering.

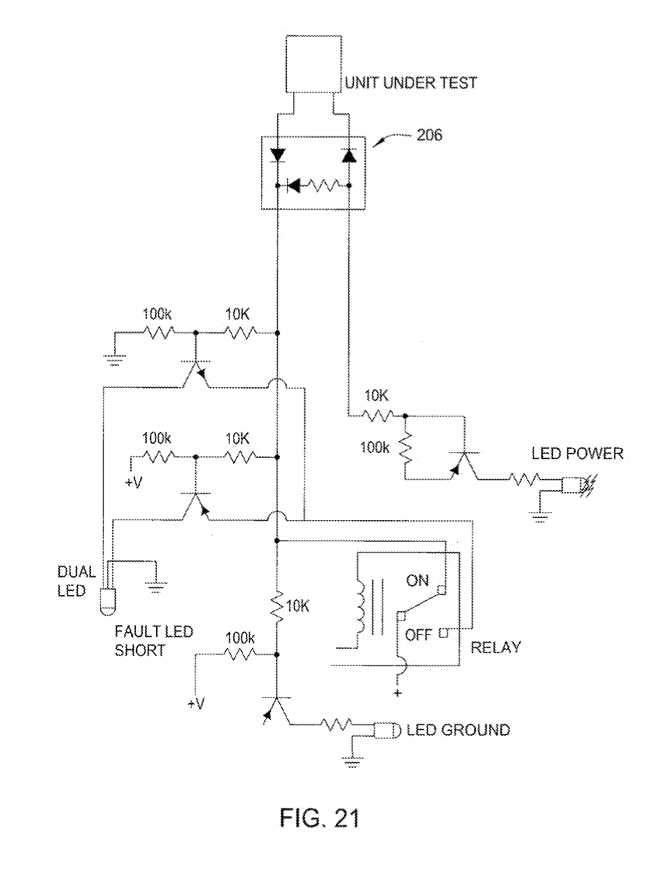

FIG. 21 is a schematic of a system check circuit configured to signal one or more faults within an electrical system (labeled the “unit under test” or UUT) to an operator of a vehicle, such as an automobile, a boat, or an airplane. The system may employ an active feedback circuit board as shown in FIG. 21 and described above to power one or more various light-emitting diodes (LEDs) or other illuminated indicators when a fault is detected.

While the foregoing is directed to embodiments of the present invention, other and further embodiments of the invention may be devised without departing from the basic scope thereof, and the scope thereof is determined by the claims that follow.

1. An apparatus for protecting a vehicle, comprising:
first and second sirens, wherein the first siren is associated with a feedback circuit;
a main alarm processing unit configured to turn on at least one of the first or second siren if one or more conditions occur;
a triggering circuit coupled to the feedback circuit, wherein if a connection between the feedback circuit and the triggering circuit is open circuited, the triggering circuit outputs a signal to the main alarm processing unit to activate the second siren.

2. The apparatus of claim 1, further comprising at least one power source, wherein the main alarm processing unit is powered by the power source.
